(19) United States
(12) Patent Application Publication
(10) Pub. No.: US 2005/0058273 A1
(43) Pub. Date: Mar. 17, 2005

(54) Methods and apparatus for detecting signaling tones in telephony data signal

(76) Inventors: Siu H. Lam, Woodcliff Lake, NJ (US); Kai X. Miao, Boonton Township, NJ (US)

Correspondence Address: BUCKLEY, MASCHOFF, TALWALKAR LLC, 5 ELM STREET, NEW CANAAN, CT, 06840, US

(21) Appl. No.: 10/660,178

(22) Filed: Sep. 11, 2003

(51) Int. Cl. H04M 7/00; H04M 1/00; H04M 9/00; H04M 3/00

(52) U.S. Cl. 379/386; 379/387.01

(57) ABSTRACT

In some embodiments, a method includes storing a telephony signal data frame in a buffer, detecting a characteristic of a subsequent telephony signal data frame, and determining wheather to analyze the stored telephony signal data frame based at least in part on a result of the detecting of the characteristic of the subsequent telephony signal data frame.

### BACKGROUND

Processing of telephone signals requires inclusion in the telephone signals of standard signaling tones such as DTMF (dual tone multi-frequency) tones or call progress tones. When a telephone signal is converted to digital form and analyzed in the form of digital data frames, proper detection of signaling tones may be compromised.

### BRIEF DESCRIPTION OF THE DRAWINGS

FIG. 1 is a block diagram of an apparatus provided according to some embodiments that receives a telephone signal in the form of telephony signal data frames.

FIG. 2 is a flow chart that illustrates a signaling tone detection process performed according to some embodiments by the apparatus of FIG. 1.

FIG. 3 is a diagram that schematically illustrates an example of processing performed in accordance with the process of FIG. 2.

FIG. 4 is a block diagram that provides an alternative representation of a portion of the apparatus of FIG. 1.

### DETAILED DESCRIPTION

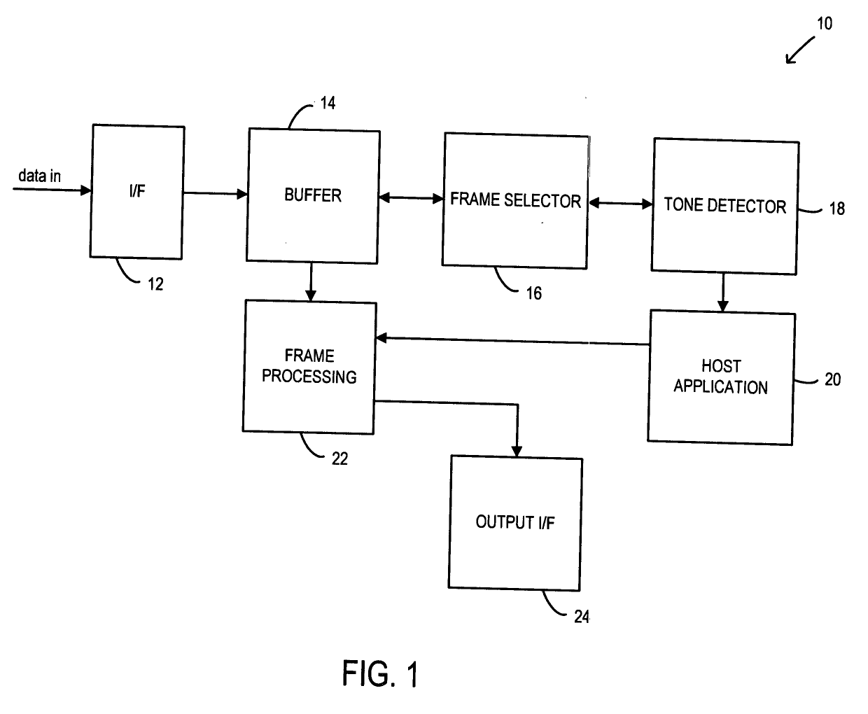

FIG. 1 is a functional block diagram of an apparatus or system 10 which receives a digital telephony signal. For example, the system 10 may be all or part of a digital PBX (private branch exchange) or an automatic call director or interactive voice response unit (IVRU).

The system 10 may include a receive interface 12 at which an input digital telephony signal is received in the form of a sequence of telephony signal data frames. The system 10 may also include a buffer 14 which is coupled to the receive interface 12 to temporarily store the incoming telephony signal data frames. The system 10 further includes a frame selector 16 which, as will be seen, controls a rate at which the telephony signal data frames are selected for tone detection processing. The frame selector 16 may be coupled to the buffer 14.

There may also be included in the system 10 a tone detector 18 which may be coupled to the frame selector 16 to perform tone detection analysis on telephony signal data frames that are stored in the buffer 14 and are selected by the frame selector 16.

Block 20 represents a host application of the system 10 that receives inputs from the tone detector 18. The inputs provided by the tone detector 18 to the host application 20 may be based on tone detection analysis performed by the tone detector 18 on the selected telephony signal data frames. The inputs from the tone detector 18 may, for example, be indicative of tones in the input digital telephony signal that are detected by the tone detector 18. In some embodiments, if the system 10 is a PBX for example, the host application 20 may perform switching functions in response to tone detection inputs from the tone detector 18. In other embodiments, if the system 10 is an automatic call director, the host application 20 may direct a call represented by the input digital telephony signal in an appropriate manner based on tone detection inputs provided by the tone detector 18. In still other embodiments, if the system is an IVRU, the host application may take suitable actions or provide suitable responses in response to tone detection inputs from the tone detector 18.

Block 22 represents a telephony signal data frame processing function or functions performed by the system 10. For example, if the system 10 is a PBX, the frame processing function 22 may transmit from the buffer 14 to an internal telephone line (not shown) telephony signal data frames temporarily stored in the buffer 14.

Block 24 represents an output interface to which the frame processing function may output data for transmission to, e.g., an appropriate output channel.

The frame selector 16, the tone detector 18, the host application 20 and the frame processing block 22 may be physically implemented in a number of different ways. For example, each of the frame selector 16, the tone detector 18, the host application 20 and the frame processing block 22 may be implemented with one or more suitable software modules to control operation of one or more general purpose processors (not separately shown), such as one or more of a digital signal processor, a microprocessor or a microcontroller. Alternatively, some or all of the frame selector 16, the tone detector 18, the frame processing block 22 and the host application 20 may be implemented as circuits (e.g., logic circuitry) that are part or all of an application specific integrated circuit (ASIC).

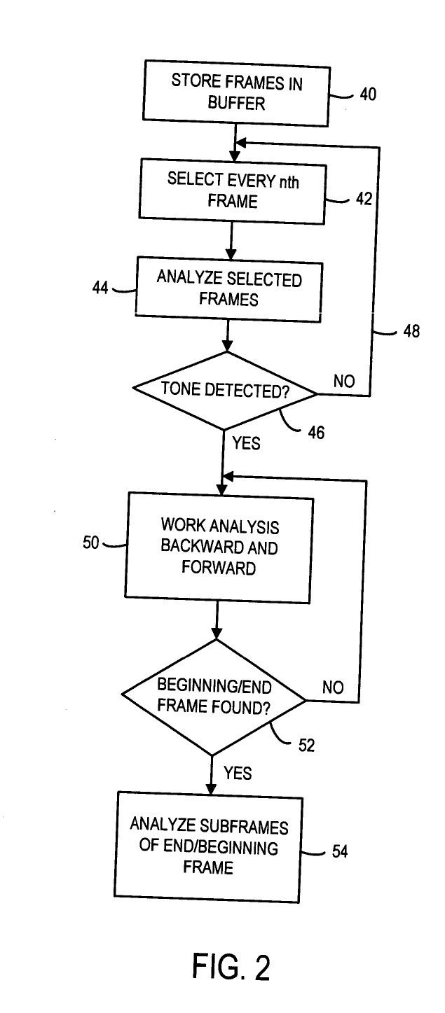

FIG. 2 is a flow chart that illustrates a tone detection algorithm performed in the system 10 according to some embodiments. As indicated at 40 in FIG. 2, each incoming telephony signal data frame is temporarily stored in the buffer 14 (FIG. 1). In some embodiments, four or five or more of the most recent telephony signal data frames may be temporarily stored in the buffer 14 at any one time. In some embodiments, for example, each of the telephony signal data frames may correspond to 10 milliseconds of the input digital telephony signal. Alternatively, other frame sizes may be employed.

Referring again to FIG. 2, at 42 it is indicated that the frame selector 16 (FIG. 1) selects every nth frame of the incoming telephony signal data frames, where n is an integer that is greater than 1. For example, if the frames correspond to 10 millisecond time periods, and if it is desired to detect tones that must have a minimum duration of 40 milliseconds to be valid, then the frame selector may select every fourth telephony signal data frame for tone detection analysis to assure that no valid tone is missed.

Referring once more to FIG. 2, it is indicated at 44 that each telephony signal data frame selected by the frame selector 16 is subjected to tone detection analysis by the tone detector 18. In some embodiments, telephony signal data frames that are not selected by the frame selector 16 are, in the first instance, not analyzed for purposes of tone detection. In other words, it may be said that non-selected telephony signal data frames are “skipped”. As will be seen, a skipped telephony signal data frame may later be analyzed for tone detection purposes in the event that a nearby subsequent telephony signal data frame is determined to include a signaling tone.

The signaling tone detection analysis performed at 44 with respect to selected telephony signal data frames by the tone detector 18 may be performed in accordance with conventional practices, for example. In some embodiments, the tone detection analysis may include performing a fast Fourier transform (FFT) with respect to each selected telephony signal data frame. As one alternative, filter bank analysis may be performed with respect to each selected telephony signal data frame. If the system operation is such that only certain tones (e.g. only digits zero through nine) are expected at certain times, the signaling tone detection analysis performed at those times on the selected telephony signal data frames may be optimized for detection of the expected signaling tones. Signaling tones that are not expected may not be detected or may be disregarded.

Once again referring to FIG. 2, a determination may be made at 46, with respect to each telephony signal data frame analyzed at 44, whether a signaling tone was detected in the telephony signal data frame. If not, as indicated at 48, selection and analysis of every nth telephony signal data frame continues until a signaling tone is detected in an analyzed frame. However, if it is determined at 46 that a signaling tone is present in a telephony signal data frame analyzed at 44, then, as indicated at 50, tone detection analysis is extended in a backwards direction (to previous frames stored in the buffer 14) and/or in a forward direction (to subsequent frames) to determine starting and/or ending points in time of the signaling tone.

More specifically, as indicated at 52, the analysis of previous or subsequent frames continues until the last or first (ending or beginning) frame of the signaling tone is found. Once the last or first frame of the tone is found, subframes of the last or first frame are analyzed, as indicated at 54, to determine the starting or ending point of the signaling tone with a finer granularity than would be possible if analysis were performed only with respect to the telephony signal data frames as originally received. It should be understood that the subframes may have the same duration as the original frames but may partially overlap with the original frames. In other words, frame A may be considered a subframe of frame B if it partially overlaps with frame B. Frame A may, but need not, have the same duration as frame B. In some embodiments, where the original frames have a duration of 10 milliseconds, the subframes may also have a duration of 10 milliseconds but may start or end at intervals of 2.5 milliseconds within each original frame. With such a procedure, the starting or ending point of a signaling tone may be determined to the nearest 2.5 milliseconds.

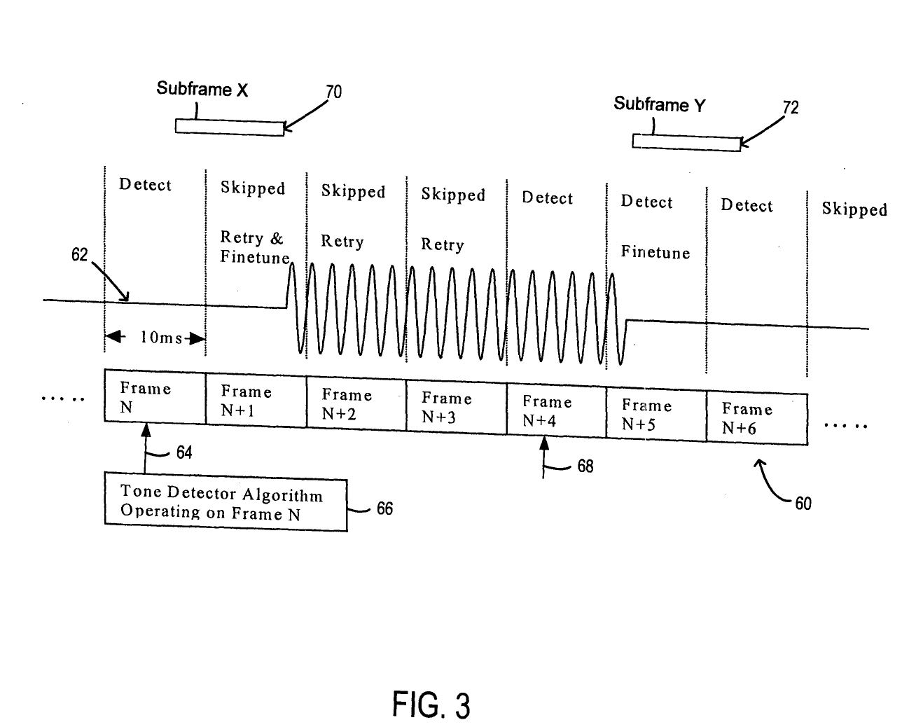

A concrete example of operation of the process of FIG. 2 will now be described with reference to FIG. 3. For the purposes of the example of FIG. 3, it is assumed that each telephony signal data frame corresponds to a duration of 10 milliseconds. It is further assumed that every fourth telephony signal data frame is selected for analysis, and that intervening (non-selected) telephony signal data frames, though stored temporarily in the buffer 14, are skipped and are not selected or analyzed unless or until one of the every fourth frames is determined to include a signaling tone.

It is also assumed in the particular example illustrated in FIG. 3 that a tone (or tone-like signal) having a duration or about 34 milliseconds is received. In this example, the tone is surrounded by silence and extends across all or part of five of the telephony signal data frames as originally received.

Reference numeral 60 in FIG. 3 indicates a sequence of telephony signal data frames that includes frames denumerated as Frame N to Frame N+6. The telephony signal data frames of the sequence 60 are temporarily stored in the buffer 14 (FIG. 1). Reference numeral 62 in FIG. 3 is a waveform that schematically illustrates the tone-like signal which begins 8 milliseconds after the start of Frame N+1 and which ends 2 milliseconds after the start of Frame N+5.

It is assumed that Frame N is one of the every fourth telephony signal data frames selected by the frame selector 16 (FIG. 1) for tone detection analysis by the tone detector 18. Selection and tone detection analysis of Frame N is indicated by arrow 64 and block 66 in FIG. 3. No signaling tone is present in Frame N, so that Frame N+4 is next selected by the frame selector 16 for tone detection analysis by the tone detector 18. The selection and analysis of Frame N+4 as the fourth telephony signal data frame after Frame N is represented by arrow 68.

In the case of Frame N+4 the signaling tone is detected by the tone detector 18. Accordingly, tone detection analysis proceeds backwards from Frame N+4 so that Frame N+3, which remains stored in the buffer 14, is selected by the frame selector 16 for tone detection analysis by the tone detector 18. The tone detector 18 determines that the signaling tone is present in Frame N+3, and as a result, Frame N+2 is selected by the frame selector 16 for tone detection analysis by the tone detector 18. In the case of Frame N+2, again the tone detector 18 determines that the signaling tone is present. Accordingly, the backward extension of the tone detection analysis proceeds further to Frame N+1, which is selected by the frame selector 16 for tone detection analysis by tone detector 18. The signaling tone is also found by the tone detector 18 to be present in Frame N+1. On the basis of this finding, it can be determined that the signaling tone began in Frame N+1, since Frame N had been previously analyzed and found not to include the signaling tone.

Since Frame N+1 is determined to be the beginning frame of the signaling tone, a more detailed (“fine tuning”) analysis may be performed with respect to Frame N+1 to more precisely determine the starting point in time of the signaling tone. In particular, one or more subframes of Frame N+1 that begin earlier in time than Frame N+1 may be selected by the frame selector 16 for tone detection analysis by the tone detector 18. For example, a Subframe X (reference numeral 70) that has a duration of 10 milliseconds and a starting point that is 2.5 milliseconds prior to the starting point of Frame N+1 may be subjected to tone detection analysis. In this case, since the tone began 8 milliseconds after the start of Frame N+1, the tone is not found to be present in Subframe X. The fine-tuning analysis of Frame N+1 can accordingly be concluded with the determination that the signaling tone began in the 2.5 millisecond period immediately prior to the end point of Frame N+1. (If tone detection analysis had indicated that the tone was present in Subframe X, then an earlier subframe, having a duration of 10 milliseconds and beginning 5 milliseconds before the starting point of Frame N+1, may next have been selected by the frame selector 16 for tone detection analysis by the tone detector 18.)

After the backward extension of the tone detection analysis from Frame N+4, forward extension of the tone detection analysis from Frame N+4 may proceed. (In other embodiments, forward extension of the tone detection analysis may be performed prior to backward extension of the tone detection analysis.) As a first operation in the forward extension of the tone detection analysis, frame selector 16 selects Frame N+5 for tone detection analysis by the tone detector 18. In the case of Frame N+5 the tone detector 18 determines that the signaling tone is present, since the tone did not end until 2 milliseconds after the starting point of Frame N+5. Accordingly, the forward extension of the tone detection analysis continues with the frame selector 16 selecting Frame N+6 for tone detection analysis by the tone detector 18. In the case of Frame N+6, the tone detector 18 determines that the tone is not present. Therefore, Frame N+5 is determined to be the ending frame for the signaling tone. A fine tuning analysis may accordingly by performed with respect to Frame N+5 to more precisely determine the ending point in time of the signaling tone. More specifically, one or more subframes of Frame N+5 that begin later in time than Frame N+5 may be selected by the frame controller 16 for tone detection analysis by the tone detector 18. For example, a Subframe Y (reference numeral 72) that has a duration of 10 milliseconds and a starting point that is 2.5 milliseconds after the starting point of Frame N+5 may be subjected to tone detection analysis.

In the particular example shown in FIG. 3, since the tone ends 2 milliseconds after the beginning of Frame N+5, the tone is not found to be present in Subframe Y. The fine-tuning analysis of Frame N+5 can therefore be concluded with the determination that the tone ended in the 2.5 millisecond period immediately after the starting point of Frame N+5. (If tone detection analysis had indicated that the tone was present in Subframe Y, then a subsequent subframe, having a duration of 10 milliseconds and beginning 5 milliseconds after the starting point of Frame N+5, may next have been selected by the frame selector 16 for tone detection analysis by the tone detector 18.)

On the basis of the fine-tuning analyses of Frames N+1 and N+5, it may be determined that the duration of the tone indicated in waveform 62 is not more than 35 milliseconds. In a regime in which signaling tones must have a minimum duration of 40 milliseconds to be considered valid, the relatively precise tone duration measurement provided by the process described above would lead to the determination that the tone indicated in waveform 62 is too short to be valid. By contrast, in a conventional tone detection algorithm, in which each 10 millisecond telephony signal data frame is subjected to tone detection analysis, the duration of the tone may incorrectly be measured as 50 milliseconds, leading to an erroneous determination that a valid signaling tone has been received.

After completion of the fine-tuning analyses of Frames N+1 and N+5, selection of every fourth incoming telephony signal data frame for tone detection analysis may resume with Frame N+10 (not shown), which is the fourth frame after Frame N+6, the last frame to be subjected to tone detection analysis. The other frames may be skipped (not selected). The selection for tone detection analysis of every fourth frame thereafter may continue until again a tone is detected in a selected frame.

Alternatively, the selection of every fourth frame for tone detection analysis may resume, for example, with Frame N+8 (not shown) and may continue with selection of Frames N+12, N+16, etc.

It should therefore be understood that a process of selecting and/or analyzing every nth frame may include selecting and/or analyzing every nth frame in a sequence of frames that begins immediately after a last frame that has been analyzed.

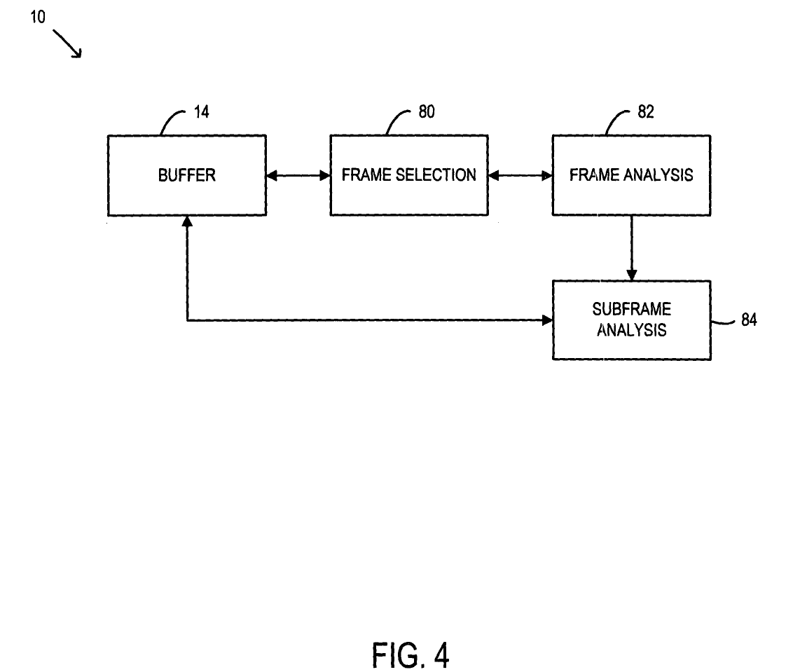

FIG. 4 is an alternative block diagram representation of portions of the system 10 shown in FIG. 1. As in the representation of FIG. 1, FIG. 4 shows a buffer 14 which temporarily stores incoming telephony signal data frames (incoming data stream not shown). Frame selection circuitry 80 is coupled to the buffer 14 to select telephony signal data frames for tone detection analysis. For example, the frame selection circuitry 80 may select every nth frame for tone detection analysis. The system 10 may also include frame analysis circuitry 82 which is coupled to and responsive to the frame selection circuitry 80. The frame analysis circuitry 82 may utilize, for example, FFT analysis or filter bank analysis to determine whether a signaling tone is present in each telephony signal data frame selected by the frame selection circuitry 80. The frame analysis circuitry 82 may also operate to extend the tone detection analysis forward and/or backward as required when a signaling tone is found to be present in a telephony signal data frame selected by the frame selection circuitry 80. The system 10 may further include subframe analysis circuitry 84 which is coupled to and responsive to the frame analysis circuitry 82. The frame analysis circuitry 84 may operate to perform the “fine-tuning” analysis with respect to telephony signal data frames found by the frame analysis circuitry 82 to be beginning or ending frames of a signaling tone. This fine-tuning analysis may be performed with respect to subframes of the beginning and/or ending frames of the signaling tone, and may be as described above in connection with FIG. 3 or at 54 in FIG. 2.

Although circuitry blocks 80, 82, 84 are shown as being separate from each other, in practice at least some of those circuitry blocks may share circuit sub-blocks. For example, an FFT analysis sub-block may be shared by frame analysis circuitry 82 and subframe analysis circuitry 84.

From the foregoing it will be recognized that, in some embodiments, the frame rate at which telephony signal data frames are analyzed to detect signaling tones may be variable. Moreover, some telephony signal data frames stored in a buffer may or may not be subjected to tone detection analysis, depending on a result of performing tone detection analysis on a subsequent frame or frames. With such an approach, there may be a substantial reduction in the computation required for tone detection analysis in comparison with conventional tone detection approaches in which every incoming frame is subjected to tone detection analysis. By skipping, say, three out of four incoming frames, except in the relatively infrequent occasions when a signaling tone is present, a large reduction in computation load may be realized. Furthermore, when a signaling tone is detected, the fine-tuning analysis described above may be performed to obtain more reliable discrimination between valid and invalid tones than is provided by conventional tone detection approaches.

It should be understood that the particular frame sizes described above may be varied. Also, the fine-tuning “granularity” may be varied.

In some embodiments, in a regime in which 30 millisecond telephony signal data frames are received, a subframe of each of such frames, corresponding to the last 10 milliseconds of the frame, may be subjected to tone detection analysis in some embodiments. When such tone detection analysis indicates a signaling tone is present, one or more other subframes of the frame or of a subsequent frame may be selected for tone detection analysis. As used herein and in the appended claims, the term “telephony signal data frame” refers to a subframe as well as a frame as originally received. Thus in the embodiment described in this paragraph, some but not all subframes are analyzed, and consequently it may be said that some but not all telephony signal data frames are analyzed.

The tone detection techniques disclosed herein have been described in the context of telephone customer premise equipment such as a PBX, an automatic call director or an IVRU. However, such techniques may also be applied in other types of telephony equipment, including for example voice-over-IP (internet protocol) gateways.

Thus, in some embodiments, a method includes storing a telephony signal data frame in a buffer; detecting a characteristic of a subsequent telephony signal data frame, and determining whether to analyze the stored telephony signal data frame based at least in part on a result of the detecting of the characteristic of the subsequent telephony signal data frame.

In other embodiments, a method includes receiving a sequence of telephony signal data frames, and analyzing some but not all of the received telephony signal data frames to determine whether a signaling tone is present in the some of the received telephony signal data frames.

In still other embodiments, a method includes selecting frames from a sequence of frames of telephony signal data, and analyzing the selected frames to determine whether a signaling tone is present in the selected frames. This method may further include, if it is determined that one of the analyzed frames includes a beginning or an end of the signaling tone, analyzing subframes of the one of the analyzed frames to determine whether the signaling tone is present in the subframes of the one of the analyzed frames. Each of the subframes may overlap a portion of the one of the analyzed frames.

The several embodiments described herein are solely for the purpose of illustration. The various features described herein need not all be used together, and any one or more of those features may be incorporated in a single embodiment. For example, skipping of incoming telephony signal data frames for the purposes of tone detection analysis may be performed without utilizing the fine-tuning analysis (subframe selection and analysis) described above. Conversely, fine-tuning analysis may be employed where indicated by detection of a beginning or ending frame of a tone even if all incoming telephony signal data frames are subjected to tone detection analysis. Therefore, persons skilled in the art will recognize from this description that other embodiments may be practiced with various modifications and alterations.

1. A method comprising:
storing a telephony signal data frame in a buffer;
detecting a characteristic of a subsequent telephony signal data frame; and
determining whether to analyze the stored telephony signal data frame based at least in part on a result of the detecting of the characteristic of the subsequent telephony signal data frame.

2. The method of claim 1, wherein the detecting of the characteristic of the subsequent telephony signal data frame includes detecting whether a signaling tone is present in the subsequent telephony signal data frame.

3. The method of claim 2, further comprising:
if the signaling tone is detected in the subsequent telephony signal data frame, analyzing the stored telephony signal data frame to detect whether the signaling tone is present in the stored telephony signal data frame.

4. The method of claim 3, wherein the analyzing of the stored telephony signal data frame includes performing a fast Fourier transform with respect to the stored telephony signal data frame.

5. The method of claim 2, wherein the detecting of the characteristic of the subsequent telephony signal data frame includes performing a fast Fourier transform with respect to the subsequent telephony signal data frame.

6. A method comprising:
receiving a sequence of telephony signal data frames;
analyzing some but not all of the received telephony signal data frames to determine whether a signaling tone is present in the some of the received telephony signal data frames.

7. The method of claim 6, wherein the analyzing of the some of the received telephony signal data frames includes performing a fast Fourier transform with respect to each of the some of the received telephony signal data frames.

8. The method of claim 6, wherein the analyzing of the some of the received telephony signal data frames includes performing a filter bank analysis with respect to each of the some of the received telephony signal data frames.

9. A method comprising:
selecting frames from a sequence of frames of telephony signal data;
analyzing the selected frames to determine whether a signaling tone is present in the selected frames; and
if it is determined that a one of the analyzed frames includes a beginning or an end of a signaling tone, analyzing subframes of the one of the analyzed frames to determine whether the signaling tone is present in the subframes of the one of the analyzed frames, the subframes each overlapping a portion of the one of the analyzed frames.

10. The method of claim 9, wherein the selecting includes selecting every nth frame from the sequence of frames of telephony signal data, n being an integer greater than 1.

11. The method of claim 10, wherein the selecting further includes selecting each frame that is immediately before or immediately after an analyzed frame that is determined to include a signaling tone.

12. The method of claim 9, wherein the analyzing of the selected frames includes performing a fast Fourier transform with respect to the selected frames.

13. An apparatus comprising:
a buffer to store a telephony signal data frame; and
circuitry coupled to the buffer and operative to:
detect a characteristic of a subsequent telephony signal data frame; and
determine whether to analyze the telephony signal data frame stored in the buffer based at least in part on a result of detecting the characteristic of the subsequent telephony signal data frame.

14. The apparatus of claim 13, wherein the circuitry is operative to detect whether a signaling tone is present in the subsequent telephony signal data frame.

15. The apparatus of claim 14, wherein the circuitry is operative, if the circuitry detects that the signaling tone is present in the subsequent telephony signal data frame, to detect whether the signaling tone is present in the telephony signal data frame stored in the buffer.

16. The apparatus of claim 14, wherein the circuitry is operative to perform a fast Fourier transform with respect to the subsequent telephony signal data frame.

17. An apparatus comprising:
a buffer to store telephony signal data frames from a sequence of telephony signal data frames; and
circuitry coupled to the buffer and operative to analyze some but not all of the telephony signal data frames stored in the buffer to determine whether a signaling tone is present in the some of the stored telephony signal data frames.

18. The apparatus of claim 17, wherein the circuitry is operative to perform a fast Fourier transform with respect to each of the some of the stored telephony signal data frames.

19. The apparatus of claim 17, wherein the circuitry is operative to perform a filter bank analysis with respect to each of the some of the stored telephony signal data frames.

20. An apparatus comprising:
frame selection circuitry to select frames from a sequence of frames of telephony signal data;
frame analysis circuitry, responsive to the frame selection circuitry, and operative to analyze the frames selected by the frame selection circuitry to determine whether a signaling tone is present in the frames selected by the frame selection circuitry; and
subframe analysis circuitry, responsive to the frame analysis circuitry, and operative to analyze subframes of frames determined by the frame analysis circuitry to include a beginning or an end of the signaling tone, to determine whether the signaling tone is present in the subframes, the subframes each overlapping a portion of a respective one of the frames.

21. The apparatus of claim 20, wherein the frame selection circuitry is operative to select every nth frame from the sequence of frames of telephony signal data, n being an integer greater than 1.

22. The apparatus of claim 21, wherein the frame selection circuitry is responsive to the frame analysis circuitry to select each frame that is immediately before or immediately after a frame that is determined by the frame analysis circuitry to include a signaling tone.

23. The apparatus of claim 20, wherein the frame analysis circuitry is operative to perform a fast Fourier transform with respect to the frames selected by the frame selection circuitry.

24. A system comprising:
an interface to receive an input signal;
a buffer coupled to the interface to store a telephony signal data frame included in the input signal; and
circuitry coupled to the buffer and operative to:
detect a characteristic of a subsequent telephony signal data frame; and
determine whether to analyze the telephony signal data frame stored in the buffer based at least in part on a result of detecting the characteristic of the subsequent telephony signal data frame.

25. The system of claim 24, wherein the circuitry is operative to detect whether a signaling tone is present in the subsequent telephony signal data frame.

26. The system of claim 25, wherein the circuitry is operative, if the circuitry detects that the signaling tone is present in the subsequent telephony signal data frame, to detect whether the signaling tone is present in the telephony signal data frame stored in the buffer.

27. The system of claim 25, wherein the circuitry is operative to perform a fast Fourier transform with respect to the subsequent telephony signal data frame.

28. An apparatus comprising:
a storage medium having stored therein instructions that when executed by a machine result in the following:
storing a telephony signal data frame in a buffer;
detecting a characteristic of a subsequent telephony signal data frame; and
determining whether to analyze the stored telephony signal data frame based at least in part on a result of the detecting of the characteristic of the subsequent telephony signal data frame.

29. The apparatus of claim 28, wherein the detecting of the characteristic of the subsequent telephony signal data frame includes detecting whether a signaling tone is present in the subsequent telephony signal data frame.

30. The apparatus of claim 29, wherein the instructions further result in:
if the signaling tone is detected in the subsequent telephony signal data frame, analyzing the stored telephony signal data frame to detect whether the signaling tone is present in the stored telephony signal data frame.

31. The apparatus of claim 30, wherein the analyzing of the stored telephony signal data frame includes performing a fast Fourier transform with respect to the stored telephony signal data frame.

32. The apparatus of claim 29, wherein the detecting of the characteristic of the subsequent telephony signal data frame includes performing a fast Fourier transform with respect to the subsequent telephony signal data frame.
